(19) United States
(12) Patent Application Publication
(10) Pub. No.: US 2009/0319354 A1
(43) Pub. Date: Dec. 24, 2009

(54) BIDDING SYSTEM FOR RECYCLABLE GOODS AND METHOD THEREOF

(76) Inventors: Ron Gonen, New York, NY (US); Morley Ivers, Toronto (CA)

Correspondence Address: MALDJIAN & FALLON LLC, 365 BROAD STREET, THIRD FLOOR, RED BANK, NJ, 07701, US

(21) Appl. No.: 12/494,099

(22) Filed: Jun. 29, 2009

Related U.S. Application Data
(63) Continuation-in-part of application No. 11/345,867, filed on Feb. 2, 2006.
(60) Provisional application No. 60/650,610, filed on Feb. 7, 2005.
(60) Provisional application No. 61/076,828, filed on Jun. 30, 2008.

(51) Int. Cl. G06Q 30/00; G06Q 50/00

(52) U.S. Cl. 705/14.23; 705/26

(57) ABSTRACT

A bidding system for recyclable goods and method thereof is disclosed. In accordance with one embodiment of the present invention, there is a method for providing incentive to engage in environmentally responsible behavior, comprises monitoring an auction event occurring on a network, the auction event comprising: receiving data at a host server regarding a recyclable good for sale associated with a seller, the seller having an account maintained on a database stored on the host server, receiving data at the host server regarding a bid for the recyclable good, the bid associated with a bidder, and determining at the host server a winning bid for the recyclable good based on a predetermined criterion; determining a credit value associated with the auction event; and allocating the credit value to the seller's account.

### CROSS-REFERENCE TO RELATED APPLICATIONS

This application is a continuation-in-part of U.S. patent application Ser. No. 11/345,867, filed Feb. 2, 2006, which claims the benefit of U.S. Provisional Patent Application Ser. No. 60/650,610, filed Feb. 7, 2005, the disclosures of which are incorporated herein by reference in their entireties. This application also claims the benefit of U.S. Patent Application No. 61/076,828, entitled “Bidding System For Recyclable Goods and Method Thereof,” filed Jun. 30, 2008, the entire disclosure of which is incorporated herein by reference in its entirety.

### BACKGROUND

1. Field of the Invention

Embodiments of the present invention generally relate to a bidding system for recyclable goods and method thereof. More specifically, embodiments of the present invention relate to a method and system for providing incentive to engage in environmentally responsible behavior.

2. Description of Related Art

With a growing interest in environmental protection, the recycling industry has become more and more active in attempting to find suitable and cost effective ways to increase recycling initiatives. Fueled by rising costs of energy, costs of waste collection, waste disposal, and the diminishing supplies of natural resources, new recycling techniques and methods are being researched. However, in order for companies to conduct these recycling protocols, techniques, or methods, they must rely on a constant inflow of recyclable materials from environmentally-conscious consumers.

The benefits of recycling include conservation of natural resources, reduction in energy costs, and diversion of wastes that would otherwise end up incinerated or dumped in landfills, which would lead to greenhouse gas emissions and toxic fumes entering the atmosphere. Unfortunately, with the lack of effective persuasive techniques implemented to encourage environmentally conscious consumers to participate in recycling activities, the result is a decrease in the inflow of recyclable materials needed for new recycling techniques and methods to succeed and be effective in the global economy.

While a great deal of money is being spent to set up recycling programs and facilities in an effort to encourage consumers to recycle recyclable materials, these programs and facilities fail to utilize persuasive techniques to convince consumers to recycle; that is, the programs fail to provide consumers with a sufficient incentive and motivation to recycle recyclable materials.

Over the past few years, with the advent of the Internet, online auctions have become very popular. Conducting an auction over the Internet has the potential to greatly expand the number of potential bidders for an auctioned item, as the number of entities with access to the auction is potentially in the millions and billions, rather than in the hundreds (as with previous general auction systems). Online auctions also allow for a wide range of products to be offered for sale to any particular buyer because of the potentially larger pool of sellers.

Thus, there is a need for a bidding system for recyclable and reusable goods and method thereof.

### SUMMARY

Embodiments of the present invention relate to a method and system for providing incentive to engage in environmentally responsible behavior. A bidding system for recyclable goods and method thereof is disclosed herein. In accordance with one embodiment of the present invention, there is provided a method for providing incentive to engage in environmentally responsible behavior, comprises monitoring an auction event occurring on a network, the auction event comprising: receiving data at a host server regarding a recyclable good for sale associated with a seller, the seller having an account maintained on a database stored on the host server, receiving data at the host server regarding a bid for the recyclable good, the bid associated with a bidder, and determining at the host server a winning bid for the recyclable good based on a predetermined criterion; determining a credit value associated with the auction event; and allocating the credit value to the seller's account.

In another embodiment of the present invention, a bidding system for providing incentive to engage in environmentally responsible behavior comprises: a host server configured to communicate with at least one seller and at least one bidder, the host server comprising a database for storing a seller's account and a computer-readable medium having computer-executable instructions for performing a method comprising: monitoring an auction event, the auction event comprising: receiving data regarding a recyclable good for sale associated with a seller, the seller having an account maintained on a database, receiving data regarding a bid for the recyclable good, the bid associated with a bidder, and determining a winning bid for the recyclable good based on a predetermined criterion; determining a credit value associated with the auction event; and allocating the credit value to the seller's account; data regarding a recyclable good for sale associated with a seller; data regarding a bid for the recyclable good associated with a bidder; a winning bid for the recyclable good; and a credit value for the seller associated with the recyclable good received.

In yet another embodiment of the present invention, a computer-readable medium having computer-executable instructions for performing a method, comprising: monitoring an auction event, the auction event comprising: receiving data regarding a recyclable good for sale associated with a seller, the seller having an account maintained on a database, receiving data regarding a bid for the recyclable good, the bid associated with a bidder, and determining a winning bid for the recyclable good based on a predetermined criterion; determining a credit value associated with the auction event; and allocating the credit value to the seller's account.

The details of one or more embodiments of the present invention are set forth in the accompanying drawings and the description below. Other features and advantages will become apparent from the description and the drawings.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts a system-level network diagram of a bidding system for recyclable goods in accordance with one embodiment of the present invention;

FIG. 2 depicts a block diagram of a general computer system in accordance with another embodiment of the present invention;

FIG. 3 depicts a block diagram of a system in accordance with yet another embodiment of the present invention;

FIG. 4 depicts a flowchart of a method for providing incentive to engage in environmentally responsible behavior in accordance with yet another embodiment of the present invention; and

FIG. 5 depicts a flowchart of a method of monitoring an auction event in accordance with the embodiment depicted in FIG. 4.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean “including but not limited to.” To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted that the examples presented herein should not be construed as limiting of the scope of embodiments of the present invention, as other equally effective examples are possible and likely.

Embodiments of the present disclosure generally relate to a bidding system for recyclable goods and method thereof. More specifically, embodiments of the present invention relate to a method and system for providing incentive to engage in environmentally responsible behavior.

As used herein, the term “recyclable good” refers to any material, which can be processed or otherwise altered in order to recover used or deteriorated material. It should be noted that recyclable goods may also include services and other intangibles. Recyclable goods may include, but is not limited to, plastics, metals, electronics, and any other suitable material in accordance with embodiments of the present invention. Additionally, as used herein, the term “credit value” refers to recyclable or redemption points or values allocated to the seller for one or more recyclable good(s) recycled.

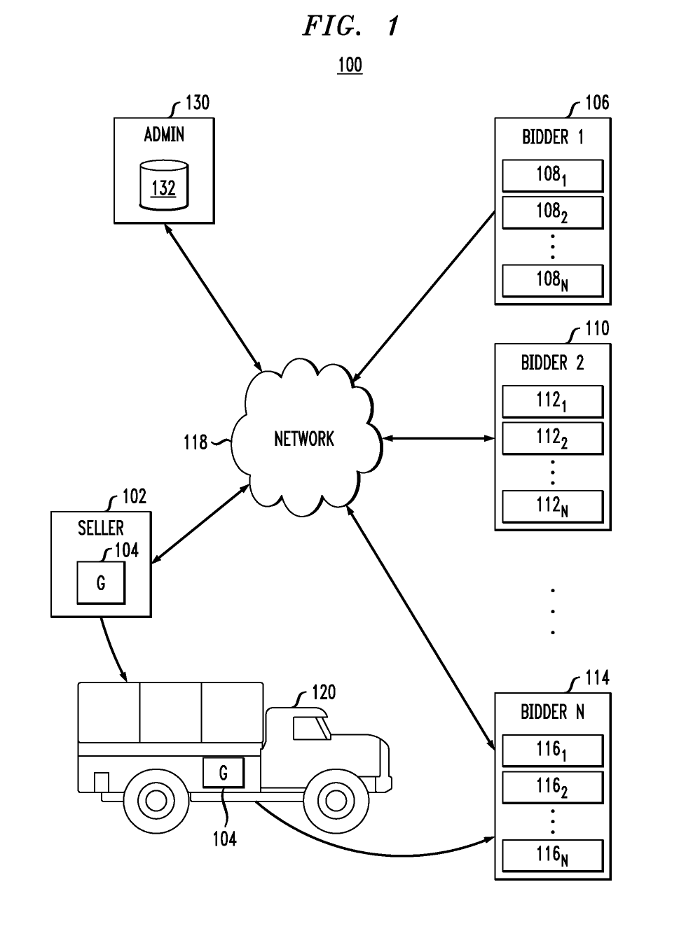

FIG. 1 depicts a basic system-level diagram of a bidding system 100 for recyclable goods in accordance with one embodiment of the present invention. The system 100 generally comprises at least a seller 102 and bidders 106, 110 or 114, each in communication with an administrator 130 through a network 118. An auction event in accordance with one or more embodiments of the present invention takes place over the network 118, which may comprise a global computer network, for example, the Internet.

Although FIG. 1 explicitly depicts three bidders (labeled “Bidder 1” 106, “Bidder 2” 110, and “Bidder N” 114), it should be appreciated that N represents any number of bidders feasible in accordance with embodiments of the present invention. For ease of reference, as used herein, each of the terms “bidder” and “bidders” may refer to any one or all of the bidders within the system 100. As understood by embodiments of the present invention, a bidder may include any person, business or entity, capable of participating in the system and methods disclosed herein.

The seller 102 may comprise any person or entity, generally in possession of at least a recyclable good 104, which the seller 102 desires to sell in an auction event. The seller 102 may have physical possession of the recyclable good 104, or alternatively, the seller 102 may have ownership of a recyclable good 104 being stored in a remote or third-party location.

In a basic embodiment, a seller 102 sets an auction listing for a recyclable good 104 through the administrator, which is viewable by one or more bidders 106. The bidders 106 may place at least one bid 108₁ on the recyclable good 104. In certain embodiments, a multitude of bids 108₁, 108₂, 108_{N} may be provided by each bidder (note: for ease of reference, bids 108₁, 108₂, and 108_{N}, where N represents any number of bids feasible in accordance with embodiments of the present invention, will be referred to collectively as 108). A bid 108 may represent an offer to purchase the recyclable good 104 at a predetermined or bidder-selected price, or may constitute a desire to negotiate an offer price by a bidder 106.

When a bidder 106 casts a bid 108 to the seller 102 for the recyclable good 104, information regarding the bid 108 may be recorded in the database 132 maintained by the administrator 130 and/or sent to the seller 102 to inform the seller 102 of the placement of a bid 108 by the bidder 106. Such information associated with the bid 108 may include the name of the bidder 106, the amount of the bid 108, the time and/or date of the bid 108, any other value or parameter feasible in the context of the present invention, or any combination thereof. In an alternative embodiment of the present invention, information regarding the bid 108 may be potentially withheld from the seller 102 prior to the determination of a winning bid and/or a winning bidder.

In accordance with one embodiment of the present invention, a bidder 106 may cast any number of bids 108 during the auction event, such as during a common live auction event in an auction house. In alternative embodiments of the present invention, bidders 106 may be restricted to a predetermined number of bids 108 during the course of the auction event. Such restrictions may include a certain period of time (e.g., no more than three bids per bidder per 24-hour period), one or more instances of an auction event (e.g., five bids per bidder per auction, ten total bids per auction irrespective of the number of bidders, etc.), silent or one-time closed bid auctions, or any other criteria feasible in the context of the present invention, or any combination thereof.

Auction bids may be conducted using any medium of exchange, which may or may not have some intrinsic value (e.g., gold) or recognized value (e.g., fiat money, such as currency). Examples of media of exchange include currency (e.g., USD, EUR, JPY, CHF, GBP, HKD, or the like), combinations of currencies (e.g., USD and EUR, JPY and CNY, or the like), tokens (such as points or credits as described in greater detail below), combinations of tokens and currencies (e.g., exchanging cash for points), any other medium of exchange feasible in accordance with embodiments of the present invention, or any combination thereof.

When the auction event has concluded, a winning bid is determined based on one or more predetermined criteria, such as highest amount bid, last bid made before the expiration of a time limit, any other criterion feasible in the context of the present invention, or any combination thereof. In many embodiments, a winning bid is determined through an automated process via backend support from the administrator. For example, the database software may comprise unique algorithms for determining the completion of an auction event, evaluating bids received, and determining a winning bid, without any additional interaction between any of the parties. When a winning bidder is established, the auction event concludes.

After a winning bidder is determined, the seller 102 arranges to transport, ship, or otherwise convey the recyclable good 104 to the winning bidder. Such transportation 120 may include physical transportation (e.g., vehicular transportation, courier shipping), electronic distribution, any other method of transportation feasible in the context of the present invention, or any combination thereof. Such transportation 120 may utilize a middleman or third-party transporter, such as a service provider or a courier service (e.g., FedEx, UPS, USPS, DHL, etc.), to facilitate the exchange of goods, services, and/or payment (i.e., media of exchange). In some embodiments, transportation may be facilitated through the system 100, whereby the seller 102 may download a postage paid label, envelope or the like, which may also comprise the bidder's address, to facilitate accuracy in shipment.

In accordance with one embodiment of the present invention, the seller 102 and/or the winning bidder may be required to make arrangements to transport the recyclable good 104 or render payment, respectively, within a certain period of time, by a certain date, in a predetermined manner, utilizing any other parameter or restriction thereupon feasible in the context of the present invention, or any combination thereof.

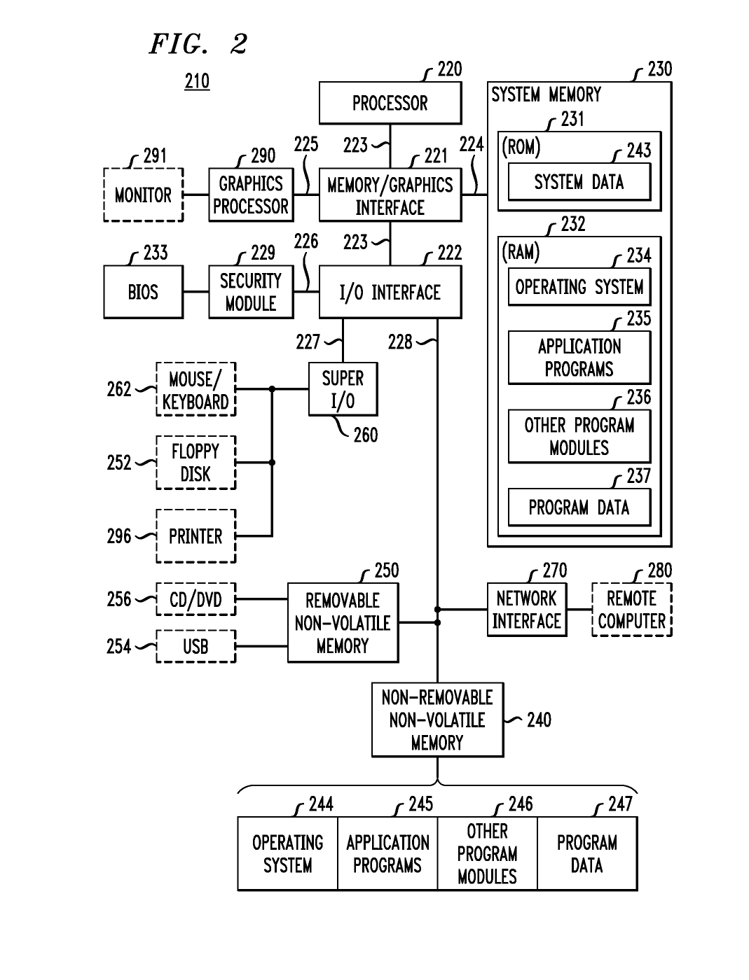

In accordance with one embodiment of the present invention, any of the administrator or bidders may comprise a general purpose computer, for example, as shown in the form of a computer 210 depicted in FIG. 2. Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

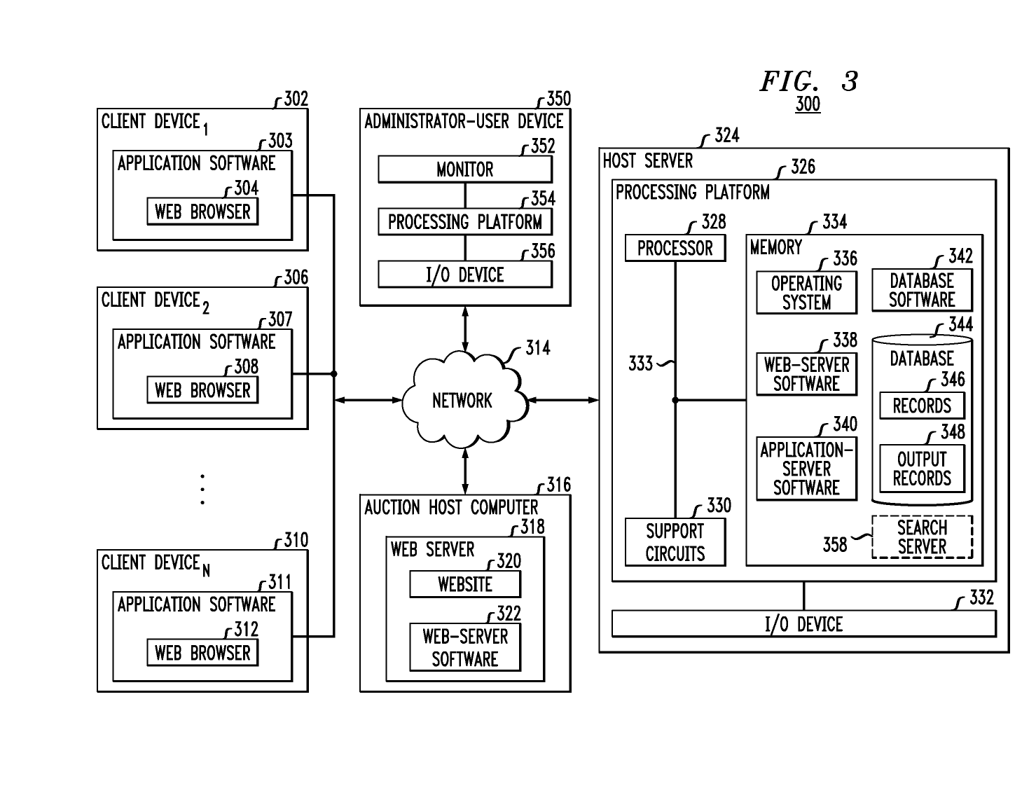

It is understood by embodiments of the present invention that a computer, such as the one depicted in FIG. 2, may be connected to a computer network or system, as discussed below with respect to FIG. 3. A computer network includes the Internet, a global computer network, an internal computer network, dedicated server networks, and the like.

FIG. 3 depicts a block diagram of a bidding system for recyclable goods in accordance with one embodiment of the present invention. The system 300 generally includes a first client device 302, a second client device 306, and additional client devices, up to client device N 310, where N represents any number of client computers feasible and/or practical for operation of embodiments of the present invention. The system further includes a network 314, a host server 324, an auction host device 316, and an administrator-user device 350. Each of these devices may comprise a basic computer console, such as the exemplary embodiment disclosed in FIG. 2, or may be more sophisticated as understood and contemplated by various embodiments of the present invention.

The host server 312, first client device 302, second client device 306, auction host device 316, and the administrator-user device 350 may be communicatively coupled together via a link or network. The host server 324, first client device 302, second client device 306 and auction host device 316 may exchange information via one or more communications carried over the network 314.

The first client device 302 may be for example, any of or any combination of a personal computer, a portable computer, a handheld computer, a cellular phone, a smart phone, a pager, a digital tablet, a laptop computer, an Internet appliance and the like, or combinations thereof. The first client device 302 may include application software 303 or similar medium capable of at least enabling the first client device 302 to connect to network 314. One example of such software application is a web browser 304. Web browser 304 enables users to display and interact with text, images, videos, and the like typically located on a web page at a website on the Internet, World Wide Web, or any other computer network. Examples of some commercially available web browsers include, but are not limited to, Internet Explorer, Mozilla Firefox, Safari, Opera, and Netscape, each created and owned by their respective recognized manufacturers.

The first client device 302 is operable to form a user interface from which a user can access the webpages provided by the web-server software 322. To facilitate this, the user interface may be communicatively coupled with the auction host computer 316 via a network 314. The user interface may be, for example, a graphical-user interface (GUI) that is operable to execute a web browser 304 application for rendering the web pages provided by the web-server software 322.

The second client device 306 and client device N 310 also include application software (307, 311), a user interface, and web browsers (308, 312). The second client device 306 and client device N 310, may be configured substantially similar to the first client device 306, such that they are independently capable of successfully operating within the system disclosed herein.

The network 314 may be a partial or full deployment of any communication or computer network or link, including any of, any multiple of, any combination of or any combination of multiples of a public or private, terrestrial wireless or satellite, and wired networks or links. The network 314 may include, for example, network elements from the Internet, core and proprietary public networks, wireless voice and packet-data networks, such as 1 G, 2 G, 2.5 G and 3 G telecommunication networks, wireless local area networks (“WLANs”), including, Bluetooth and/or IEEE 802.11 WLANs, wireless personal area networks (“WPANs”), wireless metropolitan area networks (“WMANs”) and the like; and/or communication links, such as Universal Serial Bus (“USB”) links; parallel port links, Firewire links, RS-232 links, RS-485 links, and the like.

The network elements and/or communication links may include circuit-switched as well as packet-data elements to provide transport of content, triggers and/or other information, and may be configured to communicate such information using any number of protocols and in any manner consistent with exchanging information. These protocols may include standardized, open-source, and freely-available communication protocols for communicating content in circuit-switching and/or packet data networks, and the like.

The host server 324 may be any type of server suitable for embodiments of the present invention. The host server 324 may be deployed in one or more general or specialty purpose computers, personal computers, mainframes, minicomputers, server-type computers and/or any a processor-based platform that operates on any suitable operating system, such as Windows and/or Linux, and that is capable of executing software.

The host server 324 may include a large number of elements, most of which are not shown in FIG. 3 for simplicity of description. The elements of host server 324 may be formed in a single unitary device and concentrated on a single server, client, peer or other type of node. Alternatively, the elements of host server 324 may be formed from two or more separate devices, and as such, may be distributed among a number of server, client, peer or other type nodes.

As shown, the host server 324 includes a processing platform 326 that is operable to control or otherwise manipulate an input/output (I/O) device, one or more processing units (collectively “processor”) 328, supports circuits 330, BUS 333 and memory 334.

The I/O device 332 may be any device that accepts input from a user to control, manipulate or otherwise interact with the operation of the processing platform 326. Examples of I/O devices may include any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, (vii) a pointing device, such as a mouse, joystick, trackball, touchpad, pointing stick, light pen, head pointer, soap mouse, eye tracking devices, digitizing tablet and stylus, data glove that translates the user's movements to computer gestures, (viii) a key-in device, such as a keyboard or a touchpad, (ix) and the like.

The processor 328 may be one or more conventional processors, microprocessors, multi-core processors, microcontrollers and the like. The processor 328 may execute (e.g., launch, generate, manipulate, maintain, etc.) and/or operate on the operating system 336.

The support circuits 330 facilitate operation of the processor 328, and may include well-known circuitry or circuits, including, for example, one or more I/O interfaces, one or more network interface units (“NIUs”), cache, clock circuits, data registers, power supplies and the like. The NIUs facilitate exchange (e.g., sending and/or receiving) of content. Accordingly, the NIUs may be adapted for communicating over any of, any multiple of, any combination of or any combination of multiples of terrestrial wireless, satellite, and/or wired media. The processor 328 may use the NIUs for exchanging content with the host server 324 via network 314.

The bus 333 provides for transmissions of digital information among the processor 328, memory 334, support circuits 330 and other portions of the host server 324, not shown in the Figures.

The memory 334 may store processor-executable instructions and data that may be executed by and used by the processor 328. The processor-executable instructions may include hardware, firmware, software, and the like or any combination thereof. The memory 334 may be or employ random access memory, read-only memory, optical storage, magnetic storage, removable storage, erasable programmable read-only memory and variations thereof, content addressable memory and variations thereof, flash memory, disk drive storage, removable storage, any combination thereof, and the like.

The memory 334 may store and/or receive requests from the processor 324 to execute various software packages, such as operating system 336, web-server software 338, and application-server software 340. In addition to the various software packages, the memory 334 may store database software 342 and a database 344.

The operating system 336 is the software component of the computer system that is operable to serve as a bridge between the computer hardware and application software with which the computer works. The operating system 336 acts as a host for application programs that are run on the host server 324. Some examples of various operating systems include OS/2, Java Virtual Machine, Linux, Solaris, UNIX, HPUX, AIX, Windows, MacOS, and the like.

The web-server software 338, when executed by the processor 328, may be operable to provide the user (sellers 102, bidders 106, or the like) with one or more webpages, to access their corresponding account information, access to place bids on a list of items, access to view the rewards received for each item, and other information associated with the recycling activities.

For example, web-server software 338 may post the credit value on the webpages that are accessible to the seller 102 via the first client device 302 so as to enable the seller 102 to view details of his or her account. The details of the account may include the credit value associated with the recyclable good(s) placed on auction, amount of recyclable goods sold (and/or previously sold), listing of current recyclable goods posted (and/or previously posted), summary of total credit value received for the month (and/or previous month), and the like.

In addition, the web-server software 322 when executed by the processor may be operable to allow the bidder 106, via the second client device 304, to view a list of available recyclable goods for sale, placing one or more bid(s) on a recyclable good, verifying a bid amount for the recyclable good, and the like.

The application-server software 340, when executed by the processor 328, is operable to communicate with the first client device 302, via the network 314, to obtain data corresponding to the recyclable good 104 and generate a credit value for the recyclable good 104. In addition, the application-server software 340, when executed by the processor 328, is operable to allocate the reward to the seller, post the reward to the seller account, and provide the web-server software 322 with access to the seller account.

The database 344 may include a number of records 346 into which the seller's 102 data, the recyclable goods 104 data and/or other information may be parsed and stored. The database software 342 may include and/or employ one or more database management systems (“DBMS”), such as any one of an Oracle, DB2, Microsoft Access, Microsoft SQL Server, Postgres, MySQL, 4th Dimension, FileMaker and Alpha Five DBMS, and the like. The DBMS may be operable to query the database 344, parse the information into the records 346, execute rules for sorting the information parsed into the records 346, execute rules for performing operations (e.g., mathematical, statistical, logical, etc., operations) on the information parsed into the records 346, and the like.

The database software 342 may be operable to apply the data from records 346 into one or more models to form one or more output records 348. These output records 338 include information that may be used to allocate the credit value to the seller 102 associated with carrying out recycling of recyclable goods 104. In addition to forming the output records 348, the database software 342 may be operable to interface with the web-server software 322 to allow manipulation of the database 342 via one or more web pages available to the administrator-user device 350 (“admin web pages”) over the network 314.

The website 320 consists of a collection of webpages, which may be hosted on one or several web servers 318, usually accessible via network 314 or the like. A webpage is a document, typically written in hypertext markup language (HTML), a protocol that transfers information from the web server 318 to display in the user's web browser 304, 308, and 312 respectively. The pages of the website may also generally be accessed from a common root universal resource locator (URL) called the homepage.and usually reside on the same web server 318.

Web browsers communicate with web servers primarily using hypertext transfer protocol (HTTP) to fetch web pages. HTTP allows web browsers to submit information to web servers as well as fetch pages from them.

The web server 318 may be of any type of server suitable for embodiments of the present invention. The web server 318 may be deployed in one or more general or specialty purpose computers, personal computers, mainframes, minicomputers, server-type computers and/or any a processor-based platform that operates on any suitable operating system, such as Windows and/or Linux; and that is capable of executing software.

The administrator-user device 350 may be, for example, any of or any combination of a personal computer, a portable computer, a handheld computer, a mobile phone, a digital assistant, a personal digital assistant, a cellular phone, a smart phone, a pager, a digital tablet, a laptop computer, an Internet appliance and the like.

The administrator-user device 350 may, however, include a large number of elements, many of which are not shown in FIG. 3 for simplicity of description. The administrator-user device 350 may be formed from one or more separate devices, and as such, may be distributed among a number of server, client, peer or other type nodes.

In general, the administrator-user device 350 may include a monitor 352, a processor-based platform 354 that operates on any suitable operating system, such as Windows, Linux and/or Symbian, and that is capable of executing software. The processing platform 354 may be operable to control, manipulate or otherwise interact with a monitor 352 and/or an I/O device 356.

The monitor 352 may be any suitable device that displays viewable images and/or text generated by the processing platform 354. For instance, the monitor 352 may be any of or any combination of a liquid-crystal-display based monitor, a cathode ray tube monitor, a plasma display monitor, or any other monitor that can display viewable images and the like.

The administrator-user device 350 may be operable to form a user interface through which an administrator can access the admin webpages provided by the web-server software 322. To facilitate this, the user interface may be communicatively coupled with the auction host server 316 via the network 314. The user interface may be, for example, a graphical-user interface that may be operable to execute a web browser application for rendering on the monitor 352 the admin web pages.

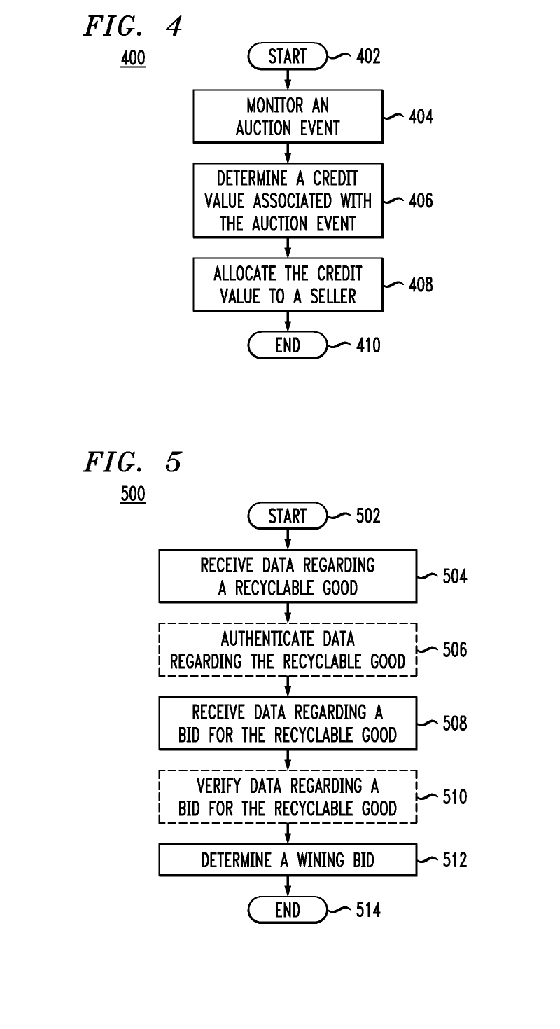

FIG. 4 depicts a flowchart of a method for providing incentive to engage in environmentally responsible behavior in accordance with yet another embodiment of the present invention. For convenience, the method 400 is described with reference to the system 300 of FIG. 3. The method 400, however, may also be carried out with other system architectures as well.

The method 400 begins at step 402. At step 404, a user of the system monitors an auction event, as described hereinabove, in accordance with one embodiment of the invention. The step 404, will be described in greater detail with respect to FIG. 5 below.

At step 406, a credit value may be determined to be associated with the auction event. A credit value may comprise any credit value, in any amount and in any form, as prescribed hereinabove. In accordance with one embodiment of the invention, a credit value associated with an auction event may be associated with the highest bid placed during the auction event by a bidder 106 for the recyclable good 104.

At some point during the auction event, qualitative or quantitative data received for the recyclable good 104 may be uploaded and stored on database 344. This data relating to the recyclable good 104 received may be used in the database 344 and along with database software 342 to determine an appropriate credit value. An algorithm, mathematical function or the like may be used as a method of determining the credit value.

In a first exemplary embodiment, the credit value may be assigned based on whether or not a user participated in the auction event, via method 400. In another exemplary embodiment, the credit value may be assigned corresponding in some manner to the amount of recyclable material a participant recycled and/or sold (via auction event) in a predetermined period of time. In yet another embodiment, the credit value may also account for a user's past history within the system (e.g., frequency of use or quality of transactions), its tier status (e.g., silver, gold, platinum), or the like.

Alternative exemplary embodiments contemplate combinations of the above, as well as similar predetermined algorithms. The database software 342 in combination with the database 344 and algorithms may provide flexibility in applying different rates for determining the credit value associated with the auction event. These rates may differ based on availability of the financial offerings, the type of entity, geographic area where the entity is located, any other data, demographic or otherwise, which is feasible in the context of the present invention, or any combination thereof. The rates may be applied in a manner such that the entities receive an optimum incentive for recycling recyclable materials and goods. A detailed description of determining the credit value is disclosed in U.S. Patent Application Publication No. 2008/0059970, entitled “Methods and System for Managing Recycling of Recyclable Material,” commonly assigned to RecycleBank, LLC, the disclosure of which is incorporated by reference in its entirety.

At step 408, the credit value may be allocated to the seller 102 associated with the recyclable good 104 sold during the auction event. Optionally, verification of the seller 102 account information may be performed to ensure a correct allocation is made to the correct seller. The credit value is allocated to the seller 102 via database software 342 and the database 344 in accordance with one embodiment of the present invention. This reward information may be entered into records 346 and linked with seller account information data. In accordance with another embodiment of the present invention, a credit value, which may be the same or different than the credit value allocated to the seller, may be allocated to an account associated with the winning bidder 106. In such an embodiment, not only is the seller 102 rewarded for recycling a recyclable good 104, but a bidder 106 is rewarded for engaging in environmentally-conscious behavior, by obtaining and potentially reusing a recyclable good rather than obtaining and using a new good.

The method 400 is concluded at step 410. However, it should be noted the method 400 may be repeated any number of times or for any number of reasons, e.g., for a multitude of users, periodically or as many times as users access the system.

In accordance with one embodiment of the present invention, a process of monitoring an auction event is depicted in FIG. 5. The method 500 begins at step 502. At step 504, the auction host computer 316 receives information pertaining to a recyclable good 104 for sale associated with at least one seller 102. Prior to step 504, on the first client device 302, the seller 102 may connect to the auction host web 316 by opening its web browser 303 and clicking on a link or manually entering a web address for the auction website 320. The web browser 303 software on the first client device sends the address to web server 322 via network 314 and requests a webpage. Web server software 322 accepts requests from first client device 303 and delivers the appropriate content back to the first client device 302.

Once the seller 102 registers and posts the recyclable good 104, the auction host computer 316 may alternatively authenticate and verify the recyclable good 104 received. The seller 102 associated with the recyclable good 104 may also set a starting bid price for the recyclable good 104, an ending date for receiving bids 108, a reserve (i.e., minimum) price for selling the recyclable good 104, any other limit for any parameter feasible in the context of the present invention, or any combination thereof. Alternatively, the admin-user may also set a starting bid price for the recyclable good 104, an ending date for receiving bids 108, a reserve (i.e., minimum) price for selling the recyclable good 104, any other limit for any parameter feasible in the context of the present invention, or any combination thereof. Once the recyclable good 104 is received, and a limit on at least a parameter is set, other data for the recyclable good 104 may be obtained, including but not limited to type or class of item, content and material(s) of item, recoverability of recyclable materials with respect to the recyclable good 104, any other data feasible in the context of the present invention, or any combination thereof. The data obtained for the recyclable good 104 should not be limited to those mentioned herein. This data is then stored into records 346 of the database 344.

In an alternative embodiment, the recyclable good 104 may be dropped off at a specified location. The admin-user may then access the admin-web pages via network 314 and enter any one or more data for the recyclable good 104 onto the website 320, which is then transferred to the database 344. After step 504, method 500 proceeds to optional step 506, or alternatively, may transition directly to step 508.

In optional step 506, the data obtained in step 504 regarding the recyclable good 104 may be authenticated. Such authentication may take the form of requiring input of item-specific data and characteristics of the recyclable good 104. In accordance with another embodiment of the present invention, authentication of the recyclable good 104 may be conducted by a third party, which may additionally be licensed or otherwise sanctioned by the system administrator. Such authentication may optionally take the form of obtaining or producing a photograph of the recyclable good 104 and making the photograph accessible to potential bidders, via uploading an electronic image of the photograph (obtainable via scanning of a “hard” photograph, taking the photograph using digital means (e.g., digital camera), etc.) onto the system. In such a manner, any potential bidder may be given confidence that the posting of the recyclable good 104 by the seller 102 is genuine (i.e., not a fraud or hollow offer for sale).

At step 508, users may log on to the website via a client device 306 via web browser 308, and search for items that are listed for auction. The user enters a search string via webpage on the website 320. The webpage then connects to the web server 318, which then connects to the search server 358 via network 314. The search server 358 then connects to the database 344 via network 314. A list of search results is then displayed on one or more web pages for the user to view. From this results list, the user has the option of placing a bid 108 on the recyclable good 104 or bypassing the listing for the recyclable good 104; in the latter case, the user may continue to search the system until a recyclable good of interest to him/her is found, at which point he/she may make a bid as outlined herein. Once a user finds a recyclable good of interest, the user via first client device 306 may place a bid 108 on the recyclable good, making the user a bidder 106 with respect to that particular auction event.

At optional step 510, once the bid 108 is received for the recyclable good 104 at step 306, the bid 108 may optionally be verified by comparing the bid data received with stored account data corresponding to the bidder 106 in database 344. Once the verification step has been completed by the database 344 and database software 342, a transaction approval may be generated and displayed on the screen of the bidder 106 via the web pages. Information regarding one or more bids 108 corresponding to the bidder 106 may then be uploaded to database 344 and stored for later transactions and viewing by the seller 102, the bidder 106, both the seller 102 and the bidder 106, any other bidder in the auction event, any combination of bidders and/or the seller 102, or none of the above.

At step 512, the application server software 340 determines a winning bid and corresponding bidder for the auction event in connection with the recyclable good 104. During this process, a comparison is made of all the bids received during the course of the auction event for the recyclable good 104. During this comparison, in accordance with one embodiment of the present invention, an algorithm or mathematical function may be employed to select which bidder has the highest bid for the recyclable good 104. Information regarding the winning bidder may then be sent to the application server software 340. The application server software 340 may then transmit this information to the web server 318. The web server 318 then transmits the information to the web pages for display. After step 512, the method 500 of monitoring an auction event ends at step 514.

Embodiments of the present invention are also provided such that the overall process may occur instantaneously. For example, in certain situations, at least one bidder 106 may have a predetermined bid 108 for a particular type of recyclable good 104, in which case an auction would be automatically completed once the recyclable good 104 were posted.

In accordance with one embodiment of the present invention, wherein a credit value is represented by points or tokens (of an indirect or non-monetary value), a user of the bidding system may redeem any amount of these points or tokens for prizes, goods, services, discounts on goods and services (e.g., coupons), credits to one or more merchants (e.g., scrip), any other prize or reward feasible in the context of the present invention, or any combination thereof. Such point redemption may take place through the system administrator, or may be granted to the user at the point of sale (e.g., 20% discount may be granted to a user when purchasing from a merchant). These rewards may be disposable (e.g., single usage) or reusable in nature, and may be distributed in any fashion, including physical fashion (e.g., via courier or mail as a paper having a scanable barcode), electronic fashion (e.g., distributed via e-mail), via any other method of distribution feasible in the context of the present invention, or via any combination of such methods.

While the foregoing is directed to embodiments of the present invention, other and further embodiments of the invention may be devised without departing from the basic scope thereof.

What is claimed is:

1. A method for providing incentive to engage in environmentally responsible behavior, comprising:
monitoring an auction event occurring on a network, the auction event comprising:
receiving data at a host server regarding a recyclable good for sale associated with a seller, the seller having an account maintained on a database stored on the host server;
receiving data at the host server regarding a bid for the recyclable good, the bid associated with a bidder; and
determining at the host server a winning bid for the recyclable good based on a predetermined criterion;
determining a credit value associated with the auction event; and
allocating the credit value to the seller's account.

2. The method of claim 1, wherein monitoring an auction event further comprises authenticating the recyclable good for sale associated with a seller.

3. The method of claim 2, wherein authenticating the recyclable good for sale associated with the seller comprises uploading at least a characteristic value of the recyclable good to a database.

4. The method of claim 1, wherein monitoring an auction event further comprises setting a limit for at least a parameter associated with the recyclable good.

5. The method of claim 4, wherein a parameter comprises one or more of a starting bid price, an ending date for receiving bids, and a reserve price.

6. The method of claim 1, wherein monitoring an auction event further comprises verifying a bid for the recyclable good associated with a bidder.

7. The method of claim 1, further comprising allocating a credit value to an account associated with the bidder, associated with the winning bid.

8. The method of claim 1, wherein the credit value associated with the auction event is distributed as at least one of points, tokens, and currency.

9. The method of claim 1, further comprising redeeming at least a credit value.

10. A bidding system for providing incentive to engage in environmentally responsible behavior, comprising:
a host server configured to communicate with at least one seller and at least one bidder, the host server comprising a database for storing a seller's account and a computer-readable medium having computer-executable instructions for performing a method comprising:
monitoring an auction event, the auction event comprising:
receiving data regarding a recyclable good for sale associated with a seller, the seller having an account maintained on a database;
receiving data regarding a bid for the recyclable good, the bid associated with a bidder; and
determining a winning bid for the recyclable good based on a predetermined criterion;
determining a credit value associated with the auction event; and
allocating the credit value to the seller's account;
data regarding a recyclable good for sale associated with a seller;
data regarding a bid for the recyclable good associated with a bidder;
a winning bid for the recyclable good; and
a credit value for the seller associated with the recyclable good received.

11. The bidding system of claim 10, wherein monitoring an auction event further comprises authenticating the recyclable good for sale associated with a seller.

12. The bidding system of claim 10, wherein monitoring an auction event further comprises setting a limit for at least a parameter associated with the recyclable good.

13. The bidding system of claim 10, wherein monitoring an auction event further comprises verifying a bid for the recyclable good associated with a bidder.

14. The bidding system of claim 10, wherein the method further comprises allocating a credit value to an account associated with the bidder associated with the winning bid.

15. The bidding system of claim 10, wherein the credit value associated with the auction event is distributed as at least one of points, tokens, and currency.

16. A computer-readable medium having computer-executable instructions for performing a method, comprising:
monitoring an auction event, the auction event comprising:
receiving data regarding a recyclable good for sale associated with a seller, the seller having an account maintained on a database;
receiving data regarding a bid for the recyclable good, the bid associated with a bidder; and
determining a winning bid for the recyclable good based on a predetermined criterion;
determining a credit value associated with the auction event; and
allocating the credit value to the seller's account.

17. The computer-readable medium of claim 16, wherein monitoring an auction event further comprises authenticating the recyclable good for sale associated with a seller.

18. The computer-readable medium of claim 16, wherein monitoring an auction event further comprises setting a limit for at least a parameter associated with the recyclable good.

19. The computer-readable medium of claim 16, wherein monitoring an auction event further comprises verifying a bid for the recyclable good associated with a bidder.

20. The computer-readable medium of claim 16, wherein the method further comprises allocating a credit value to an account associated with the bidder associated with the winning bid.
